(19) United States
(12) Patent Application Publication
(10) Pub. No.: US 2026/0061906 A1
(43) Pub. Date: Mar. 5, 2026

(54) VEHICLE SEAT SUSPENSION DEVICE AND VEHICLE SEAT

(71) Applicant: NHK SPRING CO., LTD., Yokohama-shi (JP)

(72) Inventors: Donghyoun KIM, Yokohama-shi (JP); Shinji UEHARA, Yokohama-shi (JP)

(21) Appl. No.: 19/317,766

(22) Filed: Sep. 3, 2025

(30) Foreign Application Priority Data
Sep. 4, 2024 (JP) 2024-152309
Aug. 29, 2025 (JP) 2025-144223

(51) Int. Cl. B60N 2/50; B60N 2/52; B60N 2/54

(52) U.S. Cl. CPC B60N 2/501; B60N 2/505; B60N 2/522; B60N 2/54

(57) ABSTRACT

A suspension device including a lower member, an upper member, a raising and lowering mechanism, a spring, a variable characteristic damper having an adjustable damping force, a first sensor that detects a vertical velocity of the upper member, a second sensor that detects a vertical velocity of the lower member, a memory, and a processor that is coupled to the memory and that is configured to control the damping force of the variable characteristic damper. The processor is configured so as to selectively execute a normal control mode and a bottoming out prevention control mode. In the bottoming out prevention control mode, when the first sensor or the second sensor has detected that the upward or downward direction velocity has exceeded the reference velocity, the damping force of the variable characteristic damper is adjusted to a maximum damping force.

### CROSS-REFERENCE TO RELATED APPLICATION

This application is based on and claims priority under 35 USC 119 from Japanese Patent Application No. 2024-152309 filed on Sep. 4, 2024, and Japanese Patent Application No. 2025-144223 filed on Aug. 29, 2025, the entire disclosures of which are incorporated by reference herein.

### BACKGROUND

### Technical Field

The present disclosure relates to a vehicle seat suspension device and to a vehicle seat.

### Related Art

A vehicle seat described in Japanese Patent Application Laid-Open (JP-A) No. 2021-46172 includes a biasing means configured by an air spring, an damping means that absorbs vibration of a seat, and a lock mechanism capable of locking changes of seat height.

In a vehicle seat such as described in JP-A No. 2021-46172, in order to more effectively attenuate vibration during vehicle travel, sometimes a variable characteristic damper (also called a “variable damper”) that is able to adjust damping force is employed as an damping means. When a variable characteristic damper is employed, this makes damping force adjustable in consideration of vibrations of the seat, with this accordingly enabling the ride comfort of a seated occupant to be improved. However, there is room for improvement in how specifically to control the damping force of a variable characteristic damper.

### SUMMARY

The present disclosure provides a vehicle seat suspension device and a vehicle seat that improve occupant ride comfort.

A vehicle seat suspension device of a first aspect includes a lower member that is fixed to a floor section of a vehicle body, an upper member that is disposed at an upper side of the lower member with a seat main body coupled to the upper member, a raising and lowering mechanism that couples the upper member to the lower member so as to enable raising and lowering with respect to the lower member, a spring that is resiliently deformed by raising and lowering of the upper member, a variable characteristic damper that is provided between the lower member and the upper member and has an adjustable damping force, a first sensor that detects a vertical velocity of the upper member, a second sensor that detects a vertical velocity of the lower member, and a control device that is configured to control the damping force of the variable characteristic damper based on detection results of at least one of the first sensor or the second sensor. The control device selectively executes a normal control mode and a bottoming out prevention control mode. The normal control mode is executed when the first sensor or the second sensor has detected that an upward or downward direction velocity is not greater than a predetermined reference velocity, and the damping force of the variable characteristic damper is adjusted such that a vertical velocity of the upper member with respect to the lower member is reduced in a shorter time than in a case in which the damping force of the variable characteristic damper is a constant damping force, and such that bottoming out in which the upper member and the lower member are in a state of contact is avoided. The bottoming out prevention control mode is executed when the first sensor or the second sensor has detected that the upward or downward direction velocity has exceeded the reference velocity, and the damping force of the variable characteristic damper is adjusted to a maximum damping force.

In the vehicle seat suspension device of the first aspect, the control device executes the normal control mode when the first sensor or the second sensor has detected that an upward or downward direction velocity is not greater than a predetermined reference velocity. In the normal control mode, the damping force of the variable characteristic damper is adjusted such that the vertical velocity of the upper member with respect to the lower member is reduced in a shorter time than in a case in which the damping force of the variable characteristic damper is a constant damping force, and such that bottoming out in which the upper member and the lower member are in a state of contact is avoided. In the normal control mode, damping of vibration (vertical velocity of the upper member with respect to the lower member) can be effectively performed while suppressing bottoming out in which the upper member and the lower member are in a state of contact, enabling the occupant ride comfort to be improved. Moreover, the control device executes the bottoming out prevention control mode when the first sensor or the second sensor has detected that the upward or downward direction velocity has exceeded the reference velocity. In the bottoming out prevention control mode, the damping force of the variable characteristic damper is adjusted to the maximum damping force. This thereby enables bottoming out to be prevented when the first sensor or the second sensor has detected that the upward or downward direction velocity has exceeded the reference velocity. As a result thereof, the occupant ride comfort can be suppressed from worsening due to bottoming out.

A vehicle seat suspension device of a second aspect is the vehicle seat suspension device of the first aspect, wherein the control device is configured so as to execute the bottoming out prevention control mode for a predetermined time when the second sensor has detected that an upward direction velocity has exceeded the reference velocity.

In the vehicle seat suspension device of the second aspect, bottoming out can be avoided during the above predetermined time.

A vehicle seat suspension device of a third aspect is the vehicle seat suspension device of the second aspect, wherein the control device is configured so as to execute the bottoming out prevention control mode for the predetermined time each time the second sensor has detected that the upward direction velocity has exceeded the reference velocity.

In the vehicle seat suspension device of the third aspect, the bottoming out prevention control mode is executed for the predetermined time each time the second sensor has detected that the upward direction velocity has exceeded the reference velocity. This thereby enables bottoming out to be avoided for the predetermined time described above.

A vehicle seat suspension device of a fourth aspect is the vehicle seat suspension device of any one aspect of the first aspect to the third aspect, wherein after the bottoming out prevention control mode has been executed, the control device executes a return control mode in which the damping force of the variable characteristic damper is adjusted such that the damping force of the variable characteristic damper gradually approaches the damping force of the variable characteristic damper in the normal control mode, and then executes the normal control mode.

In the vehicle seat suspension device of the fourth aspect, after the bottoming out prevention control mode has been executed, the control device executes the return control mode in which the damping force of the variable characteristic damper is adjusted such that the damping force of the variable characteristic damper gradually approaches the damping force of the variable characteristic damper in the normal control mode, and then executes the normal control mode. The return control mode is accordingly executed prior to executing the normal control mode, thereby enabling an unsettling feeling to be suppressed from occurring due to a change in ride comfort arising when the damping force of the variable characteristic damper changes suddenly.

A vehicle seat of a fifth aspect includes a seat main body in which an occupant sits, and the vehicle seat suspension device of any one aspect of the first aspect to the fourth aspect with the seat main body coupled to the upper member.

In the vehicle seat of the fifth aspect, vibration damping can be performed with good efficiency while suppressing bottoming out in which the upper member and the lower member are in a state of contact, enabling provision of a vehicle seat with good occupant ride comfort.

The vehicle seat suspension device and the vehicle seat described above enable the occupant ride comfort to be improved.

### BRIEF DESCRIPTION OF THE DRAWINGS

Exemplary embodiments of the present disclosure will be described in detail based on the following figures, wherein:

FIG. 1 is a schematic perspective view illustrating an example of a vehicle seat according to an exemplary embodiment of the present disclosure;

FIG. 2 is a schematic perspective view illustrating an example of a vehicle seat suspension device according to an exemplary embodiment of the present disclosure;

FIG. 3 is a diagram schematically illustrating the vehicle seat of FIG. 1;

FIG. 4 is a block diagram illustrating an example of a hardware configuration of a control device illustrated in FIG. 1;

FIG. 5 is an explanatory diagram schematically illustrating an operation state of a suspension device during vehicle travel;

FIG. 6 illustrates a table of one example of control modes in each segment in FIG. 5; FIG. 7 illustrates a table of another example of control modes in each segment in FIG. 5;

FIG. 8 is a graph illustrating a relationship between time and vertical velocity of a seat main body;

FIG. 9 is a graph illustrating a relationship between time and damping force of a variable characteristic damper; and

FIG. 10 is a graph illustrating a relationship between time and the damping force of a variable characteristic damper.

### DETAILED DESCRIPTION

Description follows regarding respective exemplary embodiments to implement the present disclosure, with reference to the drawings. Note that the following schematically presents a range necessary to explain how to achieve an object of the present disclosure, and mainly describes a range necessary to describe these portions of the present disclosure, with parts omitted from description being known technology. Note that sometimes some of the reference numerals are omitted in the drawings in order to make the drawings easier to read.

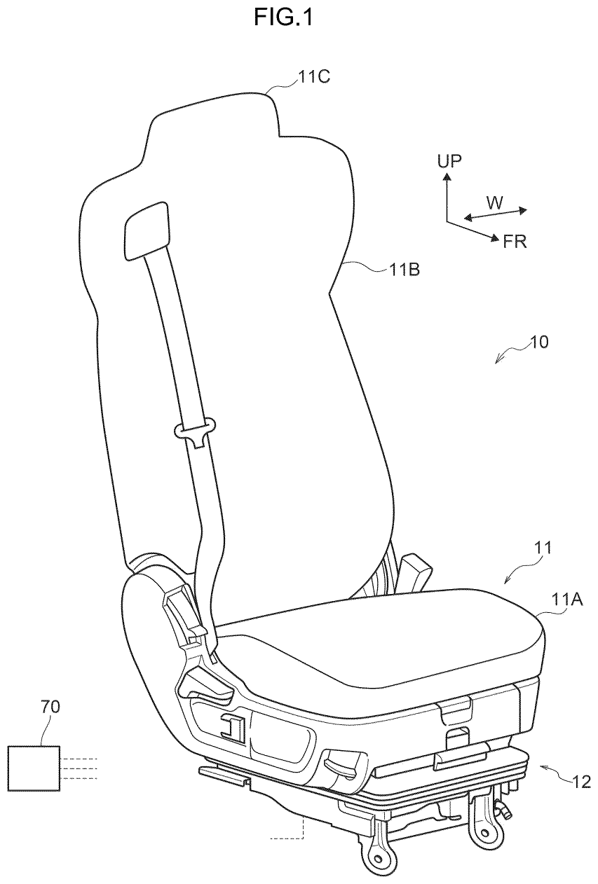

FIG. 1 is a schematic perspective view illustrating an example of a vehicle seat according to an exemplary embodiment of the present disclosure. A vehicle seat 10 according to an exemplary embodiment of the present disclosure includes, as illustrated in FIG. 1, a seat main body 11 for an occupant to sit on, and a suspension device 12 to which the seat main body 11 is coupled. Note that, as appropriate in the drawings, the arrows FR and UP respectively indicate forward and upward for the vehicle seat 10, and the arrow W indicates a width direction (or a left-right direction) of the vehicle seat 10. Where reference is simply made in the description below to front-rear, left-right, and up-down directions, these refer to such directions for the vehicle seat.

The seat main body 11 is a member for an occupant to sit on and, for example, may be configured including a seat cushion 11A to support the buttocks and thighs of an occupant, a seatback 11B to support the back of an occupant, and a headrest 11C to support the head of an occupant.

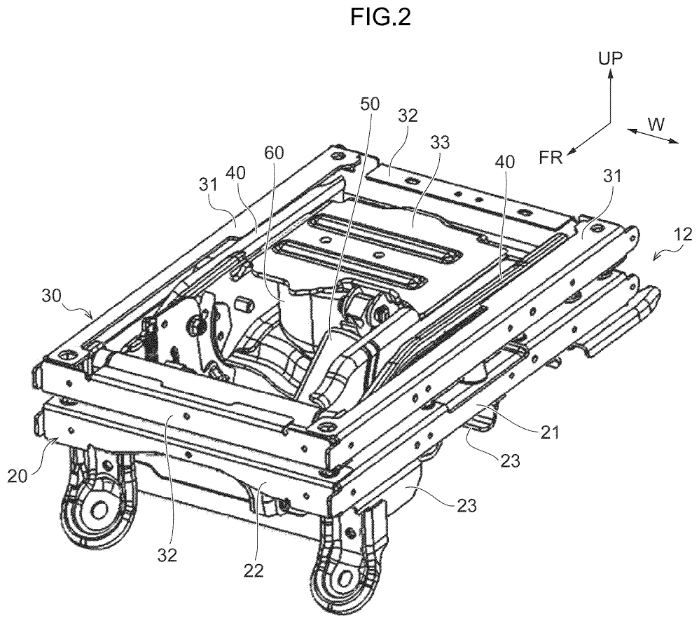

FIG. 2 is a schematic perspective view illustrating an example of a vehicle seat suspension device according to an exemplary embodiment of the present disclosure. The suspension device 12 includes, as illustrated in FIG. 2, at least a lower member 20, an upper member 30, X-links 40 serving as an example of a raising and lowering mechanism disposed between the upper member 30 and the lower member 20, an air spring 60 serving as an example of a spring, and a variable characteristic damper 50. The suspension device 12 of the present exemplary embodiment includes the variable characteristic damper 50, and is a so-called “semi-active” type of suspension. Note that although in the present exemplary embodiment the X-links 40 are illustrated as an example of a raising and lowering mechanism, another mechanism that is a mechanism capable of raising and lowering the seat main body 11, for example, a known mechanism such as a sliding mechanism or the like, may also be employed therefor. Similarly for the air spring 60, another biasing means capable of resiliently supporting the seat main body 11 may be employed. Moreover, the suspension device 12 may include configuration elements other than the configuration elements described above, for example a lock mechanism or the like to restrict vertical vibration of the seat main body 11 with respect to the vehicle body.

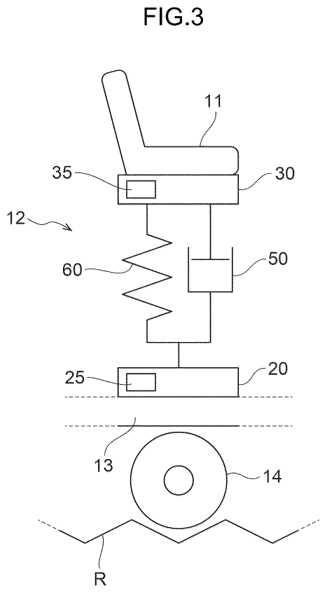

The lower member 20 is a member fixed to a floor section 13 of a vehicle body (see FIG. 3). The lower member 20 may include a left-right pair of lower rails 21, lower side coupling frames 22 that respectively couple front ends or rear ends of the pair of lower rails 21 together, and a lower bracket 23 that spans between the pair of lower rails 21. From out of these, the pair of lower rails 21 may, for example, be configured from metal plate blanks that have been press molded, and may be members elongated along the front-rear direction. The pair of lower rails 21 may have substantially U-shaped profiles open toward the left-right direction inside as viewed from the front. Moreover, the lower side coupling frames 22 and the lower bracket 23 may also be configured from metal plate blanks that have been press molded. Note that the lower side coupling frame 22 at the rear is hidden by other members in FIG. 2. Moreover, although the present exemplary embodiment is an example in which the lower member 20 is a member fixed to the floor section 13, the lower member 20 may be part of the floor section 13.

The upper member 30 is a member to which the seat main body 11 is coupled that is disposed at an upper side of the lower member 20. The upper member 30 may be configured including a left-right pair of upper rails 31, upper side-coupling frames 32 that respectively couple the front ends or rear ends of the pair of upper rails 31 together, and an upper bracket 33 that spans between the pair of upper rails 31. From out of these, the pair of upper rails 31 may be disposed so as to be parallel to and at the upper side of the pair of lower rails 21. Moreover, the pair of upper rails 31 may be configured by, for example, metal plate blanks that have been press molded, and may be members elongated along the front-rear direction. The pair of upper rails 31 may, similarly to the pair of lower rails 21, be formed with substantially U-shaped profiles open toward the left-right direction inside as viewed from the front. These upper rails 31 may be respectively coupled through the X-links 40 to the pair of lower rails 21 disposed at the lower side. The seat main body 11 is coupled to these upper rails 31 through, for example, a known seat slide mechanism. Moreover, the upper side-coupling frame 32 and the upper bracket 33 may also be configured from metal plate blanks that have been press molded. Note that although in the present exemplary embodiment an example is illustrated of a case in which the upper member 30 is a member coupled to the seat main body 11, the upper member 30 may be part of the seat main body 11, and specifically may, for example, be a cushion frame (omitted in the drawings) inside the seat cushion 11A.

The X-links 40 are links to couple the upper member 30 to the lower member 20 so as to enable raising and lowering with respect to the lower member 20. One each of the X-links 40 is respectively provided between the lower rails 21 and upper rails 31, and they may each be configured by assembling a pair of link arms together in an X-shape. Length direction intermediate portions of the pair of link arms may be coupled together so as to be able to rotate with respect to each other. One of the link arms from out of the pair of link arms configuring each of the X-links 40A may have a front end portion fixed to the upper rail 31 so as to be rotatable and slidable with respect to the upper rail 31, and may have a rear end portion fixed to the rear lower rail 21 so as to be rotatable with respect to the lower rail 21. The other of the link arms from out of the pair of link arms configuring each of the X-links 40 may have a front end portion fixed to the lower rail 21 so as to be rotatable and slidable with respect to the lower rail 21, and may have a rear end portion fixed to the rear upper rail 31 so as to be rotatable with respect to the upper rail 31. Note that specific details regarding the raising and lowering structure and the like of the X-links 40 are known, and so detailed explanation thereof will be omitted.

The air spring 60 is a member that is resiliently deformed by raising and lowering of the upper member 30, and resiliently supports the seat main body 11. The air spring 60 may be disposed between the upper bracket 33 and the lower bracket 23. The air spring 60 may, for example, be a substantially circular pillar shaped member having an axial direction along the vertical direction. An upper end portion of the air spring 60 may be fixed to the upper bracket 33, and a lower end portion of the air spring 60 may be fixed to the lower bracket 23. The air spring 60 receives load in a compression direction between the upper bracket 33 and the lower bracket 23, and is able to bias the upper bracket 33 toward the upper side with respect to the lower bracket 23. The air spring 60 is able to resiliently deform under extension and compression of the X-links 40, namely by raising and lowering of the upper rail 31. Although in the present exemplary embodiment an example is illustrated in which the air spring 60 is disposed between the upper bracket 33 and the lower bracket 23, with end portions thereof respectively fixed to the upper bracket 33 or the lower bracket 23, there is no limitation to such a structure. For example, a structure may be adopted in which an air spring 60 is disposed inside the X-link 40, with each end portion thereof respectively fixed to an end portion of the X-link 40 or to the upper member 30 or the lower member 20.

The air spring 60 may, for example, be configured such that compressed air is suppled thereto through an air tube or the like from an air compressor that configures an air brake device of the vehicle. The air spring 60 bulges upward when supplied with air, with the height position of the left and right upper rails 31 and the seat main body 11 ascending accordingly. Moreover, the air spring 60 contracts downward by air discharge, with the height position of the left and right upper rails 31 and the seat main body 11 descending accordingly. Note that the raising and lowering operation of the upper member 30 is not limited to that of the air spring 60 described above, and may be implemented by another actuator.

The variable characteristic damper 50 (also called a “shock absorber”) is provided between the lower member 20 and the upper member 30, and is a member having a specific damping force capable of absorbing vibrations of the air spring 60. A one-end portion of the variable characteristic damper 50 may be connected directly to the lower member 20, or indirectly connected thereto through part of the X-links 40 coupled to the lower member 20. Similarly, an other-end portion of the variable characteristic damper 50 may be connected directly to the upper member 30, or indirectly connected thereto through part of the X-links 40 coupled to the upper member 30. The variable characteristic damper 50 is a damper with adjustable characteristics, namely damping force. For example, a hydraulic cylinder type damper, or an MR damper using a magneto-rheological fluid (MR fluid), may be employed in the variable characteristic damper 50. The load of an occupant seated on the seat main body 11 is resiliently supported by the air spring 60, and vibrations of the seat main body 11 are absorbed by the variable characteristic damper 50. Specific methods to adjust the damping force of the variable characteristic damper 50 are described later.

FIG. 3 is a diagram schematically illustrating the vehicle seat of FIG. 1. The suspension device 12 of the present exemplary embodiment further includes, in addition to the configuration elements described above, two sensors capable of detecting vibrations arising in the vehicle seat 10. Specifically, the suspension device 12 further includes an upper-side acceleration sensor 35 serving as an example of a first sensor capable of detecting a vertical velocity of the upper member 30, and a lower-side acceleration sensor 25 serving as an example of a second sensor capable of detecting a vertical velocity of the lower member 20. Note that although in the present exemplary embodiment an example is illustrated in which acceleration sensors are employed as the first and second sensors, other sensors or the like capable of velocity detection may be employed as the first and second sensors.

The lower-side acceleration sensor 25 is, for example, attached to one of the lower rails 21 and is thereby capable of detecting vertical velocity of the lower member 20 and the floor section 13 of the vehicle body to which the lower member 20 is fixed. The lower-side acceleration sensor 25 is able to detect vibrations of the vehicle body caused by unevenness in a road surface R, via the wheels 14 and the floor section 13 of the vehicle body. The installation position of the lower-side acceleration sensor 25 is not particularly limited as long as it is able to detect vertical velocity of the lower member 20. Specifically, the lower-side acceleration sensor 25 may be installed to the floor section 13 to which the lower member 20 is coupled.

The upper-side acceleration sensor 35 is, for example by being attached to one of the upper rails 31, able to detect vertical velocity of the upper member 30 and the seat main body 11 coupled to the upper member 30. The upper-side acceleration sensor 35 is able to detect the vibrations of the seat main body 11 caused by vibrations of the vehicle body. The installation position of the upper-side acceleration sensor 35 is not particularly limited as long as it is able to detect vertical velocity of the upper member 30. Specifically, the upper-side acceleration sensor 35 may be installed to the seat cushion 11A to which the upper member 30 is coupled.

The suspension device 12 of the vehicle seat of the present exemplary embodiment further includes, in addition to the configuration elements described above, a control ECU 70 serving as an example of a control device for controlling the suspension device 12. The control ECU 70 is at least capable of controlling the damping force of the variable characteristic damper 50 based on detection results of the lower-side acceleration sensor 25 and the upper-side acceleration sensor 35. Note that the control ECU 70 may, in addition to controlling the variable characteristic damper 50, be configured so as to be capable of adjusting a seat height by operating the X-link 40 and controlling a locking mechanism and the like of a non-illustrated suspension device.

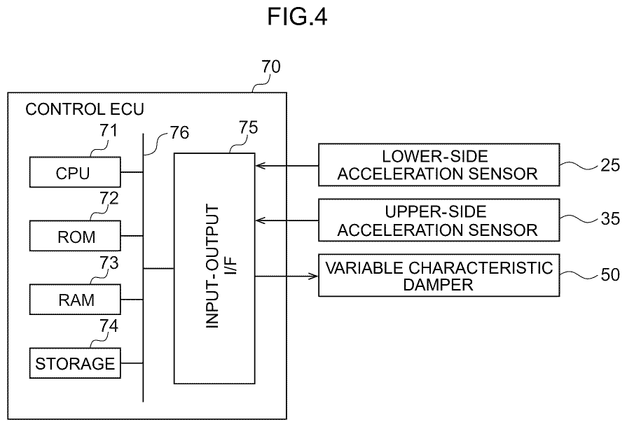

FIG. 4 is a block diagram illustrating an example of a hardware configuration of the control ECU 70 illustrated in FIG. 1. The control ECU 70 may be configured including a central processing unit (CPU) 71, read only memory (ROM) 72, random access memory (RAM) 73, storage 74, and an input-output I/F 75. The CPU 71, ROM 72, the RAM 73, the storage 74, and the input-output I/F 75 are connected together through an internal bus 76 so as to be capable of communicating with each other.

The CPU 71 is a central processing unit and is capable of executing various programs and controlling each section. Namely, the CPU 71 reads a program from the ROM 72, and executes the program using the RAM 73 as work space. In the present exemplary embodiment a program is stored on the ROM 72.

The ROM 72 is capable of storing various programs and various data. The RAM 73 serves as a working area capable of temporarily storing programs and data. Furthermore, the storage 74 is configured by a hard disk drive (HDD) or solid state drive (SSD), and is capable of storing various programs including an operating system.

The input-output I/F 75 transmits control signals to each of the configuration elements of the suspension device 12, and serves as an interface capable of collecting information acquired by each of the configuration elements. At least the lower-side acceleration sensor 25, the upper-side acceleration sensor 35, and the variable characteristic damper 50 may be electrically connected to the input-output I/F 75. In the control ECU 70, the CPU 71 identifies a control mode of the variable characteristic damper 50 based on detection results of the lower-side acceleration sensor 25 and the upper-side acceleration sensor 35 input through the input-output I/F 75, and is able execute control of the variable characteristic damper 50 by transmitting a control signal including information of the identified control mode via the input-output I/F 75. Note that details regarding control modes, and regarding a control mode identification process and the like in the CPU 71, are described later.

The CPU 71 that has acquired the detection results of the lower-side acceleration sensor 25 and the upper-side acceleration sensor 35 is able, by calculation, to identify from these detection results whether or not the upper member 30 and the seat main body 11 coupled to the upper member 30 have ascended or descended, and whether or not a force acting on the variable characteristic damper 50 is in a compression direction or in an extension direction.

Moreover, the variable characteristic damper 50 controlled by the control signal from the control ECU 70 may, for example, be configured so as to raise the damping force when supplied with current from the control ECU 70, and so as to lower the damping force when supply of current is stopped. In such cases, the variable characteristic damper 50 can be applied to switching between two damping forces having different magnitudes. Note that a method of controlling damping force of the variable characteristic damper 50 is not limited to switching between two damping forces having different magnitude as described above.

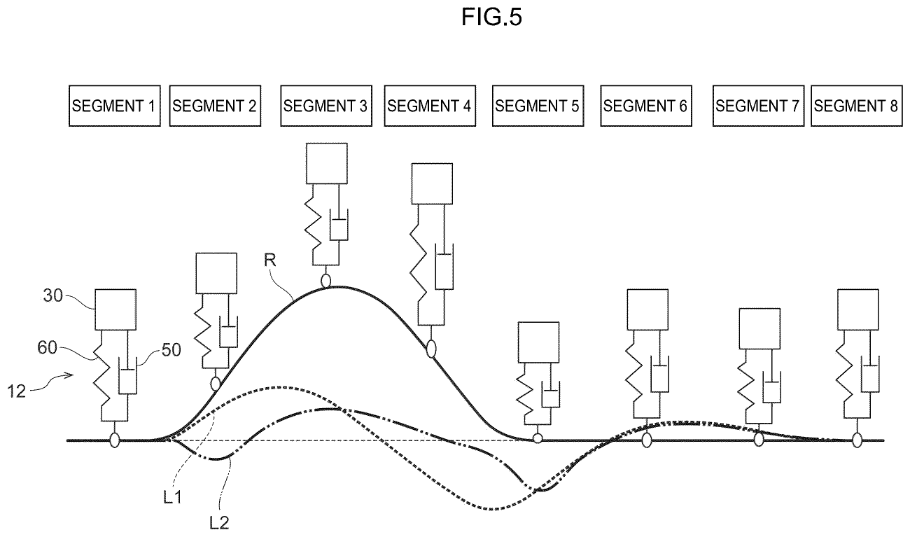

Next, description follows regarding operation of the suspension device 12 for a case in which a vehicle to which the vehicle seat 10 of the present exemplary embodiment is attached passes a step formed in a road surface R, with reference to FIG. 5.

FIG. 5 is an explanatory diagram schematically illustrating operation states of a suspension device during vehicle travel. Note that FIG. 5 illustrates a period of time from when the vehicle to which the vehicle seat 10 is attached arrives at the step formed in the road surface R during travel, passes the step, and until vibrations of the vehicle seat 10 are stabilized, with this period of time divided into segments of segment 1 to segment 8. Moreover, the suspension device 12 in FIG. 5 is illustrated respectively showing the states of the upper member 30, the variable characteristic damper 50, and the air spring 60 in each of the segments so as to be able to readily ascertain the extension/contraction state and the like of the suspension device 12.

Segment 1 in FIG. 5 is a time when the vehicle is traveling on a smooth road surface R, and the vehicle seat 10 does not vibrate in segment 1. Moreover, segment 8 in FIG. 5 is a time after vibrations of the vehicle seat 10 have stabilized, and the vehicle seat 10 does not vibrate, similarly to in segment 1.

Segment 2 in FIG. 5 is a time including a state in which the wheels 14 of the vehicle, for example the front wheels, are riding over the step. When this occurs, the lower-side acceleration sensor 25 detects an upward velocity (serving as an example of a second specific velocity) caused by a force generated by the vehicle riding over the step (sometimes this force is called a “lifting thrust”). On the other hand, the upper-side acceleration sensor 35 detects an upward velocity similar to the lower-side acceleration sensor 25 arising from the lifting thrust as described above, with this velocity being smaller than the velocity detected by the lower-side acceleration sensor 25 due to the effect of the weight of the occupant, the actions of the air spring 60 and the variable characteristic damper 50, and the like. This means that in segment 2, an ascending displacement in the upward direction is generated in the upper member 30, and in the variable characteristic damper 50, a force acts in a direction of compression due to the upper member 30 approaching the lower member 20.

Segment 3 in FIG. 5 is a time including a state in which the wheels 14 of the vehicle have arrived at the apex of the step. When this occurs, the lower-side acceleration sensor 25 is no longer able to detect any substantial vertical velocity due to the lifting thrust no longer acting. On the other hand, the upper-side acceleration sensor 35 detects an upward velocity similar to that during segment 2 due to the lifting thrust of segment 2 having a delayed action through the air spring 60 and the like. This means that in segment 3, an ascending displacement is generated in the upward direction in the upper member 30, and a force acts in the variable characteristic damper 50 in an extension direction due to the upper member 30 moving away from the lower member 20.

Segment 4 in FIG. 5 is a time when the wheels 14 of the vehicle return to their original height from the apex of the step. At this time the lower-side acceleration sensor 25 detects a downward velocity (serving as an example of a first specific velocity) caused by the vehicle descending. On the other hand, the upper-side acceleration sensor 35 detects a downward velocity similar to that detected by the lower-side acceleration sensor 25 accompanying the descending of the vehicle as described above, however this velocity is smaller than the velocity detected by the lower-side acceleration sensor 25 due to the influence of the actions of the air spring 60, the variable characteristic damper 50, and the like. This means that in segment 4, a descending displacement is generated in a downward direction in the upper member 30, and a force acts in the variable characteristic damper 50 in an extension direction due to the upper member 30 moving away from the lower member 20.

Segment 5 to segment 7 in FIG. 5 are each times from after the wheels 14 of the vehicle have passed the step until the vibrations generated in the vehicle seat 10 stabilize.

More specifically, in segment 5 to segment 7, the lower-side acceleration sensor 25 detects that the vertical velocity has become essentially zero due to having passed the step. On the other hand, the upper-side acceleration sensor 35 detects a downward velocity in segment 5 and segment 7, and detects an upward velocity in segment 6, due to vibrations that were generated in the process of passing the step. This means that in segment 5 and segment 7, a descending displacement is generated in the downward direction in the upper member 30, and a force acts in the variable characteristic damper 50 in a compression direction due to the upper member 30 approaching the lower member 20. Moreover, in segment 6, an ascending displacement is generated in the upward direction in the upper member 30, and a force acts in the variable characteristic damper 50 in an extension direction in which the upper member 30 moves away from the lower member 20. Note that graph line L1 in FIG. 5 illustrates an example of vertical displacement of the upper member 30, and graph line L2 illustrates an example of a trend in force in either the compression direction or the extension direction acting on the variable characteristic damper 50.

By adjusting the damping force of the variable characteristic damper 50 in a cycle of the above actions, the suspension device 12 according to the present exemplary embodiment suppresses vibration felt by the occupant or shrinks the time that the vehicle seat 10 vibrates, and thereby achieves an improvement in ride comfort.

Specifically, in the suspension device 12, the vibrations of the vehicle seat 10 may be actively attenuated by the variable characteristic damper 50 at timings when a step is not being ridden over or a step is not being descended, in other words at timings when the lower-side acceleration sensor 25 is not detecting a large velocity (specifically, the segments 3 and 5 to 7 in FIG. 5). An improvement in ride comfort can be expected due to being able to shorten the time when the vehicle seat 10 vibrates by actively attenuating vibrations in this manner for segments such as 3 and 5 to 7.

On the other hand, a high state of the damping force of the variable characteristic damper 50 is not necessarily preferable at timings when a step is being ridden over or a step is being descended, in other words at timings when a large velocity is being detected by the lower-side acceleration sensor 25 (specifically, in segments 2 and 4 in FIG. 5).

Specifically, for example as in the case of segment 4 described above, the damping force of the variable characteristic damper 50 acts so as to pull the upper member 30 downward in cases in which a descending displacement in the downward direction is generated in the upper member 30 accompanying the vehicle descending a step, and a force in the extension direction acts in the variable characteristic damper 50. This action becomes larger in proportion to the damping force of the variable characteristic damper 50, with an occupant feeling a large descent of the seat main body 11 when the damping force of the variable characteristic damper 50 is large, with this possibly leading to a feeling of poor ride comfort. The present exemplary embodiment accordingly, in cases such as corresponding to segment 4, decreases the force pulling the seat main body 11 downward by lowering the damping force of the variable characteristic damper 50, thereby suppressing ride comfort from worsening.

Moreover, for example such as in the case of segment 2 described above, the damping force of the variable characteristic damper 50 acts so as to lift the upper member 30 upward in cases in which an ascending displacement is generated in the upward direction in the upper member 30 accompanying a vehicle riding up over a step, and a force in the compression direction acts in the variable characteristic damper 50. This means that in segment 2, similarly to the situation described for segment 4, consideration might be given to lowering the damping force of the variable characteristic damper 50 so as to cause a drop in the force lifting the seat main body 11 upward. However, in segment 2, a force acts in the variable characteristic damper 50 in the compression direction, and accompanying this, the upper member 30 and the lower member 20 move in directions so as to approach each other. There is accordingly a concern that the upper member 30 and the lower member 20 might contact each other (this phenomenon is called “bottoming out”) were the lifting thrust to be large in such situations. Suppose that the upper member 30 and the lower member 20 were to make contact, then the vibration absorbing performance of the suspension device 12 would no longer function, leading to a significant drop in the occupant ride comfort.

In consideration of the above circumstances, the present exemplary embodiment achieves an improvement in ride comfort by adjusting the damping force of the variable characteristic damper 50 according to the detection results of the lower-side acceleration sensor 25 and/or the upper-side acceleration sensor 35, without lowering the damping force of the variable characteristic damper 50 indiscriminately in cases such as that of segment 2.

In order to implement the control described above, the control ECU 70 of the present exemplary embodiment operates the variable characteristic damper 50 in three control modes. Specifically, the control ECU 70 selectively executes three control modes: a first control mode executed when the upper-side acceleration sensor 35 detects a first specific velocity aiming downward and when the lower-side acceleration sensor 25 detects a larger velocity than the first specific velocity aiming downward; a second control mode executed when the upper-side acceleration sensor 35 detects a second specific velocity aiming upward and when the lower-side acceleration sensor 25 detects a larger velocity than the second specific velocity aiming upward; and a third control mode executed when the conditions for executing the first control mode or the second control mode are not satisfied.

The first control mode is a mode in which the damping force of the variable characteristic damper 50 is made low. More specifically this is, for example, a mode in which the variable characteristic damper 50 is placed in a state in which damping force is suppressed to low (hereafter sometimes referred to as a “first state”) by not supplying a specific power from the control ECU 70 to the variable characteristic damper 50.

The third control mode is a mode in which the damping force of the variable characteristic damper 50 is made high. More specifically this is, for example, a mode in which the variable characteristic damper 50 is placed in a state in which damping force is raised (hereafter sometimes referred to as a “second state”) by supplying the specific power from the control ECU 70 to the variable characteristic damper 50. Reference here to “damping force is made high” indicates being higher than the damping force in the first control mode, and a specific value of damping force is not particularly limited. Moreover, in the third control mode, the damping force may be varied between a maximum damping force and a minimum damping force adoptable by the variable characteristic damper 50 (based on, for example, skyhook control) according to the detection results of the lower-side acceleration sensor 25 and/or the upper-side acceleration sensor 35.

The second control mode is a mode to adjust the damping force of the variable characteristic damper 50 according to the detection results of the lower-side acceleration sensor 25 and/or the upper-side acceleration sensor 35. In the second control mode, similarly to in the third control mode, the variable characteristic damper 50 is able to vary the damping force from a maximum damping force to a minimum damping force adoptable by the variable characteristic damper 50. However, a computation method of the damping force in the second control mode is different to computation method of the damping force in the third control mode. In the present exemplary embodiment, a specific threshold is set in advance, and the second control mode is a mode in which the variable characteristic damper 50 is in a first state in cases in which the velocity detected by the lower-side acceleration sensor 25 (second specific velocity) is slower than the set threshold, and the variable characteristic damper 50 is in a second state in cases in which the detected velocity is the same as or faster than the threshold. Note that the preset threshold may be set as any velocity capable of avoiding bottoming out. The specific value of this threshold may be set in consideration of a distance between the upper member 30 and the lower member 20, the resilience of the air spring 60, and the like. Moreover, although an example is described in the present exemplary embodiment of a case in which it is the velocity detected by the lower-side acceleration sensor 25 that is compared to a threshold, instead of this, the velocity detected by the upper-side acceleration sensor 35, or velocities detected by both the lower-side acceleration sensor 25 and the upper-side acceleration sensor 35, may be compared to threshold(s).

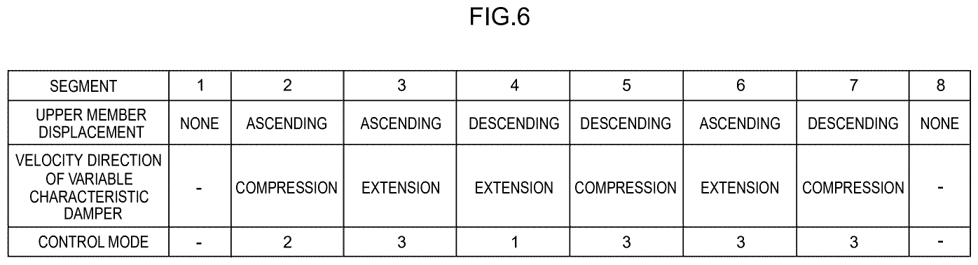

FIG. 6 illustrates as a table of an example of control modes for each of the respective segments in FIG. 5. Each of the control modes described above can be applied to respective segments, as illustrated in FIG. 6. Namely, the variable characteristic damper 50 is operated in the second control mode when traveling in segment 2, the variable characteristic damper 50 is operated in the third control mode when traveling in segments 3, and 5 to 7, and the variable characteristic damper 50 is operated in the first control mode when traveling in segment 4. Note that because vibration is not generated in the vehicle seat 10 during travel in segments 1 and 8, the control mode of the variable characteristic damper 50 is not particularly limited and, for example, may be operation in the second control mode.

As stated above, in the suspension device 12 and the vehicle seat 10 including the suspension device 12 according to the present exemplary embodiment, the vibration by the variable characteristic damper 50 can be effectively attenuated by the variable characteristic damper 50. In addition thereto, bottoming out can also be avoided from occurring due to the second control mode being executed in the segment 2, and good occupant ride comfort can be realized.

Although in the exemplary embodiment described above, the variable characteristic damper 50 is illustrated for an example in which the damping force is switchable in two steps by whether or not current is being supplied, for example, a variable characteristic damper 50 capable of switching in three or more steps by adjusting current being supplied may be employed. More specifically, for example, a variable characteristic damper 50 can be employed that, in addition to the first state having a low damping force and the second state having a high damping force as described above, is also able to be operated in a third state operating at an damping force between the damping force of the first state and the damping force of the second state. In such cases, the control ECU 70 may employ the third state described above as the second control mode. In the second control mode, due to the variable characteristic damper 50 being operated in the third state, namely at an damping force between the damping force of the first state and the damping force of the second state, the vibration of the vehicle seat 10 can be stabilized in a shorter period of time while still suppressing bottoming out.

In addition to the example described above, although the damping force in the third state described above may be a specified value, it may also be adjustable stepwise according to the detection results of the lower-side acceleration sensor 25 and/or the upper-side acceleration sensor 35. As stated above, bottoming out can be suppressed more reliably by making the damping force adjusted in the second control mode. Similarly, the damping force can be caused to be generated more finely based on known skyhook control by making the damping force adjusted in the third control mode.

Moreover although, as illustrated in FIG. 6, in the exemplary embodiment described above an example is given of a case in which the control ECU 70 employs three modes of the first to third control modes as the normal control mode executed, the normal control mode may be two modes as described below.

FIG. 7 illustrates a table of another example of control modes in each segment in FIG. 5. In a control ECU of a suspension device according to a modified example of the above exemplary embodiment, as illustrated in FIG. 7, a fourth control mode is adopted instead of the above second control mode and third control mode. The fourth control mode may be a mode in which the damping force of the variable characteristic damper 50 made high that is executed when the conditions for execution of the first control mode are not satisfied. Reference here to being made high indicates either the above second state or third state.

In the suspension device according to the modified example described above, the first control mode and the fourth control mode are selectively executed based on the detection results of the upper-side acceleration sensor 35 and the lower-side acceleration sensor 25. This means that the damping force of the variable characteristic damper 50 is in a high state due to the fourth control mode being executed during travel in segment 2 in FIG. 5, and so bottoming out can be suppressed more reliably, and an improvement in ride comfort can be expected.

### Bottoming Out Prevention Control Mode

The lifting thrust previously described becomes even higher depending on the height of a step a vehicle passes and the velocity when the step is passed, and conceivably bottoming out is unable to be avoided in a normal control mode in which the three modes of the first to third control modes are employed, and in a normal control mode in which the two modes of the first and fourth control modes are employed. However, in the present exemplary embodiment, in a case in which the lifting thrust is expected to exceed the predetermined threshold, the control ECU 70 is configured such that a bottoming out prevention control mode is executed to adjust the damping force of the variable characteristic damper 50 to a maximum damping force.

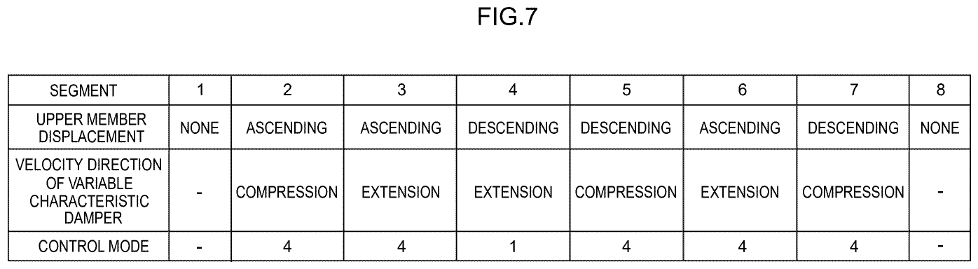

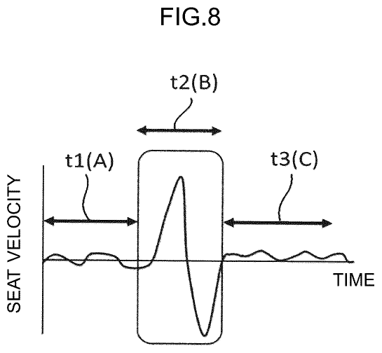

FIG. 8 is a graph illustrating a relationship between time and vertical velocity of the seat main body 11, with time indicated along the horizontal axis, and vertical velocity of the seat main body 11 indicated on the vertical axis. Note that FIG. 8 illustrates a waveform when a vehicle to which the vehicle seat 10 has been attached travels in sequence in a segment A during time t1, in segment B during time t2, and in a segment C during time t3. Moreover, FIG. 9 is a graph illustrating a relationship between time and damping force of the variable characteristic damper 50, with time indicated along the horizontal axis, and damping force of the variable characteristic damper 50 indicated on the vertical axis.

As illustrated in FIG. 8, the lifting thrust is not greater than a predetermined threshold in a state in which the vehicle is traveling in segment A and segment C, and the lifting thrust temporarily exceeds the predetermined threshold in a state in which the vehicle is traveling in segment B. Namely, an upward direction velocity detected by the lower-side acceleration sensor 25 does not exceed a predetermined reference velocity in the states in which the vehicle is traveling in segment A and segment C, and an upward direction velocity detected by the lower-side acceleration sensor 25 temporarily exceeds the predetermined reference velocity in the state in which the vehicle is traveling in segment B.

As illustrated in FIG. 8 and FIG. 9, the control ECU 70 executes the normal control mode in the state in which the vehicle is traveling in segment A. This means that vibration can be effectively attenuated by the variable characteristic damper 50 in the state in which the vehicle is traveling in segment A, and also occurrence of bottoming out can be avoided, and good occupant ride comfort can be realized. Note that a configuration may be adopted in which the normal control mode is executed based on the velocity detected by the upper-side acceleration sensor 35. Moreover, a configuration may be adopted in which the normal control mode is executed based on both velocities of the velocity detected by the upper-side acceleration sensor 35 and the velocity detected by the lower-side acceleration sensor 25.

Moreover, the control ECU 70 executes the bottoming out prevention control mode when an upward direction velocity detected by the lower-side acceleration sensor 25 temporarily exceeds the predetermined reference velocity accompanying a vehicle travelling in the segment B. The damping force of the variable characteristic damper 50 is thereby adjusted to the maximum damping force. This thereby enables bottoming out to be prevented when the upward direction velocity detected by the lower-side acceleration sensor 25 (upward direction velocity of the lower-side acceleration sensor 25) has exceeded the reference velocity. As a result thereof, the occupant ride comfort can be suppressed from worsening due to bottoming out.

The control ECU 70 may also execute the bottoming out prevention control mode for a predetermined time when the upward direction velocity detected by the lower-side acceleration sensor 25 has exceeded the predetermined reference velocity. For example, the bottoming out prevention control mode may be executed for three seconds when the upward direction velocity detected by the lower-side acceleration sensor 25 has exceeded the predetermined reference velocity. Moreover, the control ECU 70 may be configured so as to execute the bottoming out prevention control mode for a predetermined time every time that the upward direction velocity detected by the lower-side acceleration sensor 25 has been detected as exceeding the predetermined reference velocity. For example a configuration may be adopted in which, when the upward direction velocity detected by the lower-side acceleration sensor 25 has been detected as exceeding the predetermined reference velocity, determination is made to execute the bottoming out prevention control mode for three second. Then if the upward direction velocity detected by the lower-side acceleration sensor 25 at two second after this determination has again exceeded the predetermined reference velocity, determination is made to again execute the bottoming out prevention control mode for three second execution from this determination. In such cases the prevention control mode will be executed for five seconds. Adopting such control enables bottoming out to be avoided for the predetermined time described above. Note that a configuration may be adopted so as to execute the bottoming out prevention control mode based on the velocity detected by the upper-side acceleration sensor 35. Moreover, a configuration may be adopted so as to execute bottoming out prevention control mode based on both velocities of the velocity detected by the upper-side acceleration sensor 35 and the velocity detected by the lower-side acceleration sensor 25. Moreover, a configuration may be adopted in which the time of the bottoming out prevention control mode is prolonged according to an amount of excess velocity with respect to the reference velocity.

In the state in which the vehicle is travelling in the segment C, the upward direction velocity detected by the lower-side acceleration sensor 25 is not greater than the predetermined reference velocity. The control ECU 70 accordingly executes the normal control mode. When the damping force of the variable characteristic damper 50 is suddenly changed when switching from the bottoming out prevention control mode to the normal control mode, conceivably an unsettling feeling is felt to the change in ride comfort. In order to address this, a return control mode may be executed as described below.

As illustrated in FIG. 9, after the bottoming out prevention control mode has been executed, the control ECU 70 executes the return control mode to adjust the damping force of the variable characteristic damper 50 such that, over a predetermined time t4, the damping force of the variable characteristic damper 50 gradually approaches the damping force of the variable characteristic damper 50 in the normal control mode, and then after this executes the normal control mode. In this manner, by executing the return control mode prior to executing the normal control mode, an unsettling feeling of a change in ride comfort due to the damping force of the variable characteristic damper 50 suddenly changing can be suppressed from occurring.

### Control Considering Short Height Occupant

However, in cases in which an occupant of shorter height than an average height is seated in the vehicle seat 10, the occupant has a tendency to sit with the height position of the seat main body 11 set low. Conceivably the stroke of the variable characteristic damper 50 is restricted and bottoming out is liable to occur when the height position of the seat main body 11 is set low. Description follows regarding control of a control section for a case in which the height position of the seat main body 11 is set lower than a predetermined position.

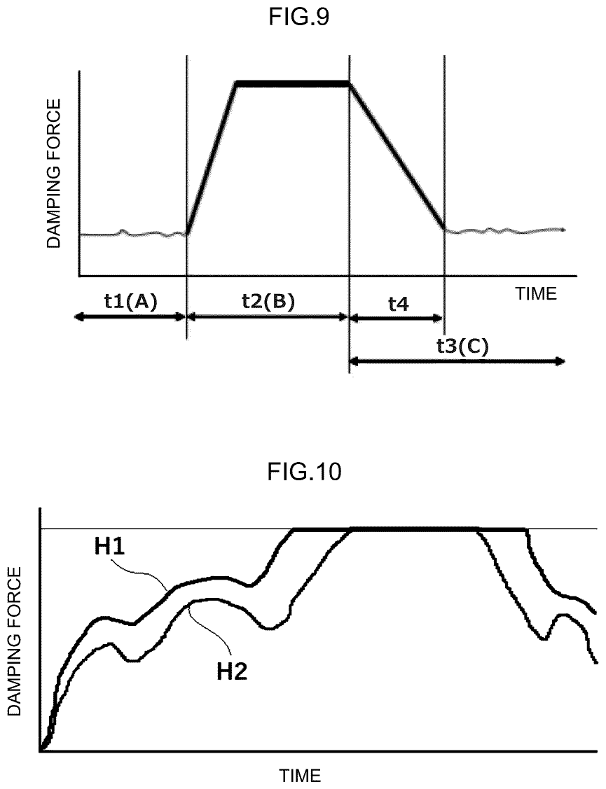

FIG. 10 is a graph illustrating a relationship between time and damping force of the variable characteristic damper 50 when traveling along the same road surface under the same conditions, with time indicated along the horizontal axis, and damping force of the variable characteristic damper 50 indicated on the vertical axis. A waveform indicated by annotation H2 on the graph is a waveform of a case in which the height position of the seat main body 11 is set at a height of a predetermined position or greater, the waveform indicated by annotation H1 is a waveform of a case in which the height position of the seat main body 11 is set to a height less than the predetermined position. As indicated in the graph, when the height position of the seat main body 11 is detected by the control ECU 70 as being set to a height less than the predetermined position, the control ECU 70 executes the bottoming out prevention control mode at an earlier stage than configuration in which the height position of the seat main body 11 has been set to a height of the predetermined position or greater. This thereby enables bottoming out to be effectively suppressed from occurring when the height position has been set to a height less than the predetermined position.

The present disclosure is not limited to the above exemplary embodiments, and various modifications may be implemented within a range not departing from the spirit of the present disclosure. All of such modifications are contained in the technical idea of the present disclosure.

What is claimed is:

1. A vehicle seat suspension device, comprising:
a lower member that is fixed to a floor section of a vehicle body;
an upper member that is disposed at an upper side of the lower member, with a seat main body coupled to the upper member;
a raising and lowering mechanism that couples the upper member to the lower member so as to enable raising and lowering with respect to the lower member;
a spring that is resiliently deformed by raising and lowering of the upper member;
a variable characteristic damper that is provided between the lower member and the upper member and has an adjustable damping force;
a first sensor that detects a vertical velocity of the upper member;
a second sensor that detects a vertical velocity of the lower member;
a memory; and
a processor that is coupled to the memory and that is configured to control the damping force of the variable characteristic damper based on detection results of at least one of the first sensor or the second sensor,
wherein the processor is configured so as to selectively execute:
a normal control mode when the first sensor or the second sensor has detected that an upward or downward direction velocity is not greater than a predetermined reference velocity, wherein, in the normal control mode, the damping force of the variable characteristic damper is adjusted such that a vertical velocity of the upper member with respect to the lower member is reduced in a shorter time than in a case in which the damping force of the variable characteristic damper is a constant damping force, and such that bottoming out in which the upper member and the lower member are in a state of contact is avoided, and
a bottoming out prevention control mode when the first sensor or the second sensor has detected that the upward or downward direction velocity has exceeded the reference velocity, wherein, in the bottoming out prevention control mode, the damping force of the variable characteristic damper is adjusted to a maximum damping force.

2. The vehicle seat suspension device of claim 1, wherein:
the processor is configured so as to execute the bottoming out prevention control mode for a predetermined time when the second sensor has detected that an upward direction velocity has exceeded the reference velocity.

3. The vehicle seat suspension device of claim 2, wherein:
the processor is configured so as to execute the bottoming out prevention control mode for the predetermined time each time the second sensor has detected that the upward direction velocity has exceeded the reference velocity.

4. The vehicle seat suspension device of claim 1, wherein:
after the bottoming out prevention control mode has been executed, the processor is configured to execute a return control mode in which the damping force of the variable characteristic damper is adjusted such that the damping force of the variable characteristic damper gradually approaches the damping force of the variable characteristic damper in the normal control mode, and then execute the normal control mode.

5. A vehicle seat, comprising:
a seat main body in which an occupant sits; and
the vehicle seat suspension device of claim 1 with the seat main body coupled to the upper member.
